(19) United States
(12) Patent Application Publication
(10) Pub. No.: US 2026/0154689 A1
(43) Pub. Date: Jun. 4, 2026

(54) SYSTEMS AND METHODS FOR PREVENTING ELDER FRAUD THROUGH CARD WHITELISTING

(71) Applicant: The PNC Financial Services Group, Inc., Pittsburgh, PA (US)

(72) Inventor: Madeleine Anne Thomey, Cleveland Heights, OH (US)

(73) Assignee: The PNC Financial Services Group, Inc., Pittsburgh, PA (US)

(21) Appl. No.: 19/378,494

(22) Filed: Nov. 4, 2025

Related U.S. Application Data
(63) Continuation of application No. 18/775,600, filed on Jul. 17, 2024.
(60) Provisional application No. 63/620,722, filed on Jan. 12, 2024.

(51) Int. Cl. G06Q 20/40; G06Q 20/42

(52) U.S. Cl. CPC G06Q 20/405; G06Q 20/42

(57) ABSTRACT

The disclosed embodiments describe systems and methods for authorizing a transaction request and may include a server with a processor configured to access a database. The database may store data including: vendor information for at least one vendor, user preferences for each vendor, and permissions associated with the vendor information and the user preferences. The processor may be configured to: receive, from a device in communicative connection with the server, input via a user interface, the input being associated with the data; update the permissions based on the input; determine, based on the input or the stored data, whether the at least one vendor is associated with the permissions; provide, based on the determination that the at least one vendor is associated with the permissions, an approval for the transaction request to a second device in communicative connection with the server, using a transaction engine.

### CROSS-REFERENCE TO RELATED APPLICATIONS

The present application claims the benefit of priority of U.S. Provisional Application No. 63/620,722, filed Jan. 12, 2024, the entire contents of which are incorporated herein.

### TECHNICAL FIELD

The present disclosure relates generally to systems and methods for card whitelisting for preventing fraudulent transactions. More specifically, the present disclosure relates to maintaining and using a whitelisting database to assist a caregiver in preventing fraudulent transactions by a care receiver.

### BACKGROUND

The present disclosure relates generally to systems and methods for preventing fraud perpetrated against vulnerable people. More specifically, the present disclosure relates to credit or debit card whitelisting of merchants by a caregiver to prevent elder fraud.

Fraudulent activity poses an enduring challenge in commerce, eroding trust, financial stability, and consumer confidence. For example, fraudulent practices within the banking sector present a substantial risk to both the industry and bank customers, who rely on banks to safeguard against such activities. Vulnerable demographics, such as the elderly, are particularly at risk of being targeted for scams, exacerbating the potential for significant losses to both financial institutions and individuals. As fraudulent tactics evolve, the need for robust preventive measures and detection mechanisms becomes increasingly pressing. Prevention of fraudulent activity is essential for safeguarding the well-being of vulnerable individuals and enhancing overall financial security.

Presently, purchasing transactions conducted through vendors, whether online or in person are typically carried out with a significant degree of freedom, albeit with some degree of fraud prevention measures in place. For example, financial institutions such as banks or credit card companies may maintain a denylist or blacklist comprising certain vendors deemed to pose a higher risk to vulnerable customers. Additionally, traditional security protocols, such as rejecting unusually large purchases or those made from atypical locations, are commonly employed by banks. While these measures offer some level of protection, they may not always suffice in preventing everyday fraudulent activities that target vulnerable individuals. Additionally, dependent persons may lack the cognitive or intellectual bases for maintaining finances or being completely financially independent. For example, an elderly person may be suffering from dementia, or a child may be careless with money. When shopping, there is a need for allowing a caregiver to protect vulnerable individuals from fraudulent activity while maintaining the individuals'autonomy. To address this gap, there is a need for a system maintaining and using a whitelisting feature managed by a caregiver for credit card or debit card transactions conducted by a vulnerable person, as shown and described in the present application.

### SUMMARY

The disclosed embodiments describe systems and methods for authorizing a transaction request. The disclosed embodiments may include a server with at least one processor configured to access at least one database, wherein the at least one database stores data including: vendor information for at least one vendor, user preferences for each vendor of the at least one vendor, and permissions associated with the vendor information and the user preferences. The processor may be further configured to receive, from a device in communicative connection with the server, input via a user interface, the input being associated with the data. The processor may be further configured to update the permissions based on the input. The processor may be further configured to determine, based on the input or the stored data, whether the at least one vendor is associated with the permissions. The processor may be further configured to provide, based on the determination that the at least one vendor is associated with the permissions, an approval for the transaction request to a second device in communicative connection with the server, using a transaction engine.

According to some embodiments, the device may be operated by a caregiver and the second device may be utilized by a care receiver.

According to some embodiments, the care receiver may include at least one of: an elderly person, a child, a person with a disability, or a dependent person.

According to some embodiments, the user preferences may be associated with the caregiver and the care receiver.

According to some embodiments, the processor may be further configured to provide the approval if a transaction cost associated with the transaction request is at or below a predetermined transaction threshold.

According to some embodiments, the processor may be further configured to automatically allow or disallow the transaction request for the at least one vendor in the permissions.

According to some embodiments, the processor may be further configured to operate a notification system configured to provide a communication seeking approval or disapproval of the transaction request via an application accessed by the device.

According to some embodiments, the notification system may receive approval or disapproval of the transaction request from the application accessed by the device.

According to some embodiments, the permissions may include at least one approved category of vendors, wherein if the at least one vendor is in the approved category of vendors, the transaction request is automatically approved.

According to some embodiments, the processor may be further configured to generate a denylist including unacceptable vendors for which the transaction request is automatically denied.

According to some embodiments, the denylist may include at least one disapproved category of vendors, wherein if the at least one vendor is in the disapproved category of vendors, the transaction request is automatically denied.

According to some embodiments, the denial of the transaction request may occur in real time, within a predetermined time duration.

According to some embodiments, the approval of the transaction request may occur automatically in real time, within a predetermined time duration.

According to some embodiments, the permissions may include a geolocation for the at least one vendor.

According to some embodiments, the approval of the transaction request may occur automatically based on the geolocation of the second device.

According to some embodiments, the device may provide disapproval of the transaction request automatically based on the geolocation of the second device.

According to some embodiments, the processor may be configured to receive a new transaction request at a new vendor not on the permissions and automatically determine whether to approve or disapprove the new transaction request based on characteristics of the new vendor or the new transaction request.

According to some embodiments, the determination may include using at least one of: time series analysis, exponential smoothing, seasonal decomposition of time series, or Bayesian statistics.

According to some embodiments, the determination may include using a machine learning model trained on previous transaction information.

According to some embodiments, the previous transaction information may include type of vendor or vendor location.

According to some embodiments, the processor may be further configured to operate an authentication system to authenticate the device.

The disclosed embodiments describe systems and methods for updating information associated with exchanges. The disclosed embodiments may include at least one server configured to operate at least one processor. The at least one processor may be configured to update an exchange database with at least one new exchange, the exchange database including an exchange history. The at least one processor may be configured to update a user database with user information provided by at least one caregiver through a user interface on a device, the user database including a user history. The at least one processor may be configured to update a permissions database based on input from the device for at least one vendor or at least one exchange, the permissions database including a plurality of vendors and information for a plurality of exchanges. The at least one processor may be configured to send an exchange decision for the at least one new exchange based on the permissions database, the user database, and the exchange database to a second device.

The disclosed embodiments describe systems and methods for determining an attempted exchange. The disclosed embodiments may include a server with at least one processor configured to receive, from a device in communicative connection with the server, a permitted vendor for an exchange. The at least one processor may be configured to receive, from the device, a permission level associated with the exchange for the permitted vendor. The at least one processor may be configured to store the permitted vendor and the permission level in at least one database. The at least one processor may be configured to allow the exchange when the exchange occurs at the permitted vendor and an amount of the exchange is at or below the permission level, or prevent the exchange when the exchange occurs at an unpermitted vendor or the amount of the exchange is above the permission level.

According to some embodiments, the processor may be configured to receive a new exchange at a new vendor and automatically determine whether to approve or disapprove the new exchange based on characteristics of the new vendor or the new exchange.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 shows an illustration of a potential care receiver, caregiver, and vendor of the systems and methods, consistent with the disclosed embodiments.

FIG. 2 shows an illustration of a potential care receiver using card whitelisting of the systems and methods, consistent with the disclosed embodiments.

FIG. 3 shows an example system environment for a caregiver providing a whitelist for a care receiver, consistent with the disclosed embodiments.

FIG. 4 shows an example system environment for accessing information related to a transaction at a POS device using the whitelist, consistent with the disclosed embodiments.

FIG. 5 shows an example system environment for enabling or disabling a transaction at a POS device using the whitelist, consistent with the disclosed embodiments.

FIG. 6 shows an example system environment for enabling or disabling a transaction at a POS device using location and the whitelist, consistent with the disclosed embodiments.

FIG. 7 shows an example system environment for providing a notification to a caregiver, consistent with the disclosed embodiments.

FIG. 8 shows example process for approving or disapproving a transaction, consistent with the disclosed embodiments

FIG. 9 shows an example process for authorizing a transaction request, consistent with disclosed embodiments.

FIG. 10 shows an example process for updating information associated with exchanges, consistent with disclosed embodiments.

FIG. 11 shows an example process for determining an attempted exchange, consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

The systems and methods disclosed herein may be aimed at preventing fraud against vulnerable individuals. There is an enduring challenge of fraudulent activity in commerce, particularly within the banking sector, with an especially heightened risk faced by vulnerable demographics such as the elderly. While some current fraud prevention measures exist, they do not fully address everyday fraudulent activities targeting vulnerable individuals. Thus, the proposed solution advocates for a whitelisting feature managed by caregivers to enhance protection in transactions for vulnerable persons.

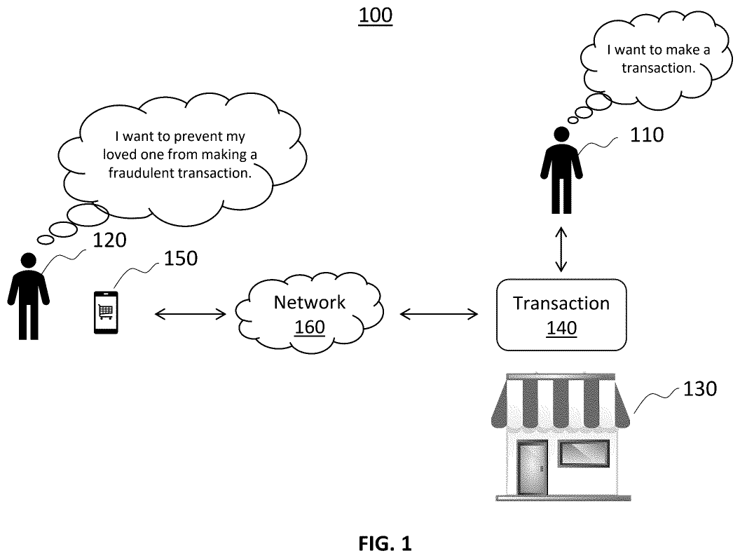

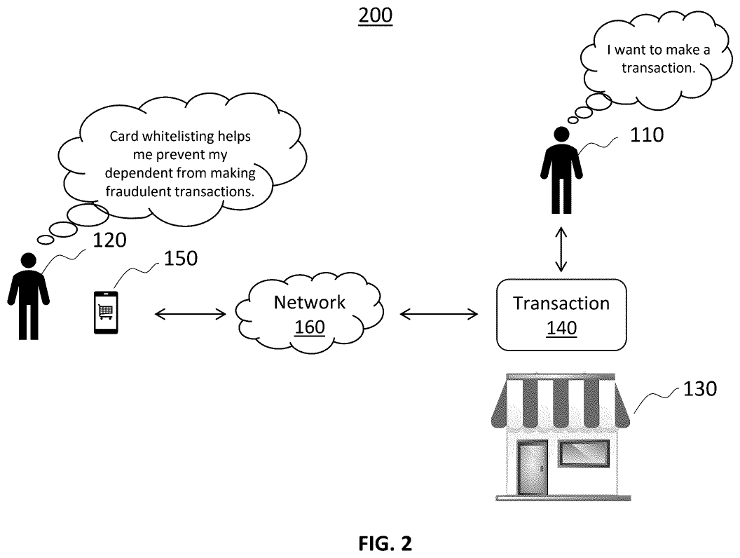

FIG. 1 provides illustration 100 of a potential care receiver 110, caregiver 120, and vendor 130 of the systems and methods consistent with the disclosed embodiments. Caregiver 120 may wish to initiate transaction 140 at vendor 130. Caregiver 120 using caregiver device 150 may wish to prevent fraudulent transactions by monitoring or managing control of transaction 140 through network 160. The various components of illustration 100 (and FIGS. 2 to 6) may communicate over a network 160. Such network communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols.

Vendor 130 may be any entity involved in the distribution or sale of a product. A product may be any goods or service. Vendor 130 may be an online merchant, a brick-and-mortar store, or any physical person or entity attempting to exchange money for transaction 140. Vendor 130 may refer to any actor of the commercialization process, including manufacturers, distributors, wholesalers, or retailers. Transaction 140 may be any exchange or interaction between two or more parties where a product or anything of value is transferred between the parties.

As described herein, care receiver 120 may be any individual who is vulnerable or susceptible to fraudulent activities. In some embodiments, the care receiver may include any combination of an elderly person, a child, a person with a disability, or a dependent person. An elderly person may be a senior citizen or an elder, who has reached an advanced age, typically associated with retirement or later stages of life. A child may be anyone under the legal age of adulthood. A person with a disability may be a person who has physical, cognitive, sensory, or developmental impairment that may hinder their ability to perform certain tasks. A dependent person may be a person who relies on others for support, care, or assistance in meeting their daily needs. These persons may be assigned caregiver 120 by family, friends, a doctor, a lawyer, the government, by voluntary arrangement, or any other means. Caregiver 120 may have any manner of relationship to care receiver 110. Caregiver 120 may be an individual providing assistance, support, or care to care receiver 110. Caregiver 120 may monitor or manage the financial affairs of care receiver 110, including purchases such as transaction 140. For example, if care receiver 110 wishes to make transaction 140 when purchasing a product at vendor 130, caregiver 120 may block transaction 140 using one of the system environments as described herein.

In some embodiments, caregiver 120 and care receiver 110 may share an account used for transaction 140. For example, the account may be a bank account at a financial institution. In such an arrangement, it may be easier for caregiver 120 to monitor the account if the name of caregiver 120 name is also on the account. For example, the account may be a joint account, or an account with a dependent as the primary user and caretaker 120 as a guardian. The account may be set up to associate one individual as a caregiver role and the other as a care receiver role. For example, underage children often are dependents on a bank account with their parent as the guarantor (e.g. caregiver 120). Alternatively, in some embodiments, caregiver 120 and care receiver 110 may not share an account used for transaction 140. For example, care receiver 110 may wish to maintain autonomy or privacy from caregiver 120 and keep a separate account.

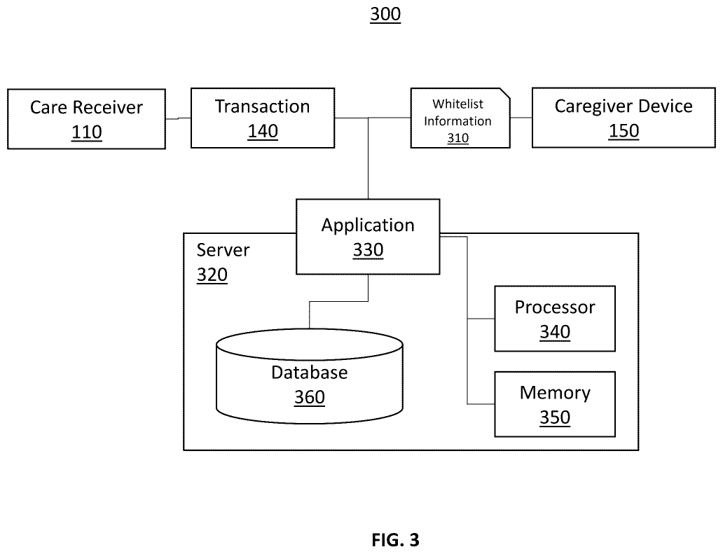

Caregiver device 150 may refer to any device operated by caregiver 120 for the purposes of establishing or maintaining a whitelist for care receiver 110. A whitelist may be a list of items, entities, or individuals that are explicitly determined to be acceptable within a particular context. As used herein, a whitelist may be a list of vendors or transactions that are approved for care receiver 110 by caregiver 120, such as during transaction 140. The approved vendors or transactions may be approved by caregiver 120 using caregiver device 150. In some embodiments, caregiver device 150 may be a computer (e.g. tablet, desktop or laptop computer). In some embodiments, caregiver device 150 may be a smartphone configured to run a mobile device version of application 330 (as described further with respect to FIG. 3). A smartphone may be any mobile device that can run software applications. For example, a smartphone may be an Android™ device, an iPhone™ device, etc.

FIG. 2 shows an illustration of caregiver 120 using card whitelisting, consistent with the systems and methods disclosed herein. FIG. 2 incorporates many of the elements of FIG. 1. Card whitelisting may be a feature used by financial institutions and individuals to restrict the use of payments for transaction 140 used by care receiver 110. Card whitelisting may refer to any of the systems of methods described herein.

In some embodiments, caregiver device 150 may be operated by caregiver 120 and a second device may be utilized by care receiver 110. The second device may allow care receiver 110 to initiate transaction 140. In some embodiments, the second device may be a computer, smartphone, or any point-of-service (POS) device (described in further detail in relation to FIGS. 3-6 below). In some embodiments, the second device may initiate a transaction through any combination of a credit card, a debit card, or a bank transfer. A bank transfer may refer to any exchange of funds between two parties'bank accounts. The bank transfer may include direct bank-to-bank transfer (e.g. electronic funds transfer, automated clearing house transfer, or wire transfer) or peer-to-peer services (e.g. Zelle™, Venmo™, Cash App™, or PayPal™). The credit card or debit card may include contactless payment (e.g. tap and go, tap to pay, Google Pay™, or Apple Pay™), inserting the card into a card reader, or any other payment method that uses a bank card directly or indirectly. Payment may be made using a biometric method, including fingerprint identification, voice recognition, facial recognition, etc. For example, the second device may use a biometric method to identify care receiver 110 while making transaction 140. In some embodiments, caregiver device 150 may use a biometric method to identify caregiver 120. For example, caregiver 120 may use a face identification method to log into an application on caregiver device 150.

In some embodiments, caregiver device 150 and the second device utilized by care receiver 110 may be at least one computer. For example, transactions may be done over the Internet using a laptop computer. Caregiver 120 may use the or a different computer from that used by care receiver 110 for amending the whitelist.

In some embodiments, caregiver device 150 and the second device utilized by care receiver 110 may each be a smartphone with an application that communicates with server 320. The smartphone may include payment options such as Apple Pay™ or Google Pay™. The smartphone may also include credit card or debit card scans or saved information to be used with online merchants (e.g. Apple Wallet™).

Caregiver 120 may implement card whitelisting by generating a whitelist for transactions by care receiver 110, as illustrated in FIG. 2. In some embodiments, a whitelist (i.e. vendor whitelist) may include an approved category of vendors. A category of vendors may refer to any grouping of vendor 130 based on at least one feature that each group has in common. Vendor 130 may be categorized based on types of products or services offered, size of vendor 130, geographic location, suppliers, etc. For example, caregiver 120 may select a particular category of vendor 130 for transaction 140 to be automatically approved up to a set limit.

In some embodiments, the vendor whitelist may include location information for the at least one vendor. Location information may be any data that identifies the location of an entity (e.g. vendor 130). Location information may include global positioning system (GPS) coordinates, WiFi network positioning, cellular tower positioning, IP addresses, physical address, etc. For example, caregiver 120 may wish to allow all transactions for vendor 130 at a given postal code, region, or general area.

In some embodiments, caregiver 120 may also provide a denylist (or blacklist) comprised of unacceptable vendors. A denylist may be a list of entities to be denied access or privileges to a system or service. At unacceptable vendors, care receiver 110 may be prohibited from any transaction, such as transaction 140 altogether. Caregiver 120 may also identify a disapproved category of vendors for which all transactions should be blocked. In some embodiments, the denylist may include at least one disapproved category of vendors. One benefit of allowing all transactions to be blocked for a category of vendors is that caregiver 120 is not required to identify or predict each individual vendor 130 or each transaction at each vendor 130. In some embodiments, the denylist may include vendor location information. For example, caregiver 120 may wish to restrict all transactions at a particular store, postal code, region, or general area.

FIG. 3 shows example system environment 300 for caregiver 120 providing a whitelist for care receiver 110, consistent with the disclosed embodiments. Any information related to the whitelist (i.e. whitelist information 310) may be given by caregiver 120 to server 320 through application 330. Whitelist information 310 may refer to any data or details that may be included in or associated with the whitelist. For example, whitelist information 310 may include vendor names, Internet Protocol (IP) addresses, vendor addresses, transaction limits (e.g. spending cap), or any other information that may be useful in implementing the whitelist.

Application 330 may be any software program designed to interface with caregiver device 150 and server 320 to facilitate transaction 140. Application 330 may have a graphical user interface (GUI), which allows caregiver 120 to input information related to establishing the whitelist. The input may include any combination of text, number, selection, date and time, file, image, audio, sensor, or gesture. For example, application 330 may be a sub-application within a financial institution's banking application. Caregiver 120 may log into application 330, providing access to view relevant accounts, including at least one account for care receiver 110. Application 330 may allow caregiver 120 to review or update whitelist information 310. For example, whitelist information 310 may be presented in tables with cells including rows and columns, and caregiver 120 may directly edit any cell. Application 330 may provide a search function to search for whitelist information 310. Application 330 may allow caregiver 120 to directly add, delete, or update any information related to caregiver 120, care receiver 110, vendors, or transactions, including any thresholds for purchases, consistent with disclosed embodiments.

In some embodiments, server 320 may include at least one processor 340, memory 350, and database 360. Server 320 may be a computer or a system that provides resources, data, services, or functionality to other computers, devices, or users within a network (e.g. network 160). Processor 340 may include various types of processing devices. For example, processor 340 may include a microprocessor, preprocessors (such as an image preprocessor), a graphics processing unit (GPU), a central processing unit (CPU), support circuits, digital signal processors, integrated circuits, processor memory, or any other types of devices suitable for running applications and for image processing and analysis. In some embodiments, processor 340 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures.

Memory 350 may be a non-transitory memory, such as a flash memory, a random-access memory (RAM), etc. Memory 350 may be configured to store data, such as computer codes or instructions executable by processor 340. The disclosed embodiments are not limited to any particular configuration of memory 350.

Database 360 may refer to an organized collection of information or data (e.g. structure data) stored electronically in a computer system or other storage medium. Database 360 may be a repository for storing, querying, and manipulating data, facilitating data-driven decision-making processes and supporting various applications and services. Database 360 may include tables, records, fields, keys, indexes, relationships, and any data values. Database 360 may be configured to enable efficient data storage, retrieval, and management operations. Database 360 may contain a variety of data related to care receiver 110, caregiver 120, vendor 130, transaction 140, etc. For example, server 320 may exist entirely or in part within a cloud-computing system or cloud network. A cloud network may be a network of remote servers hosted and accessed through the Internet to store, manage, or process data. In some embodiments, database 360 may be located on a separate server located on another network. In some embodiments, database 360 may be part of a third-party server system. Database 360 may include any database shown in FIGS. 3-6.

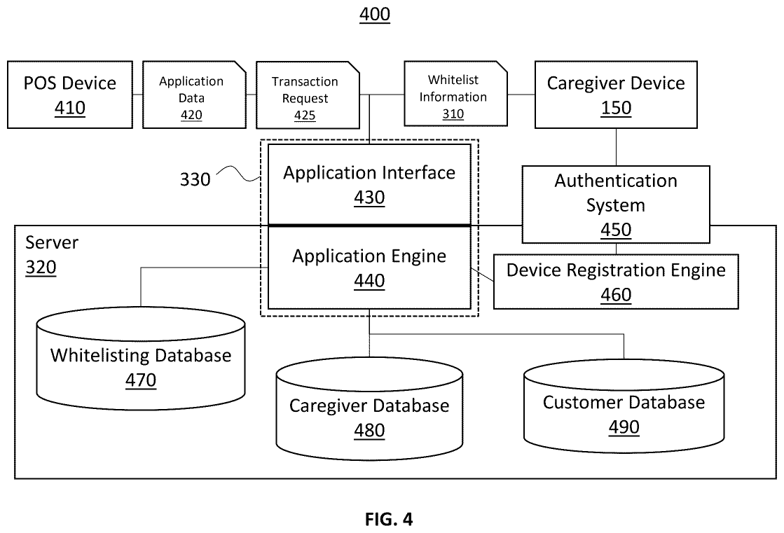

FIG. 4 shows example system environment 400 for accessing information related to transaction 140 at POS device 410 using the whitelist, consistent with the disclosed embodiments. POS device 410 may send application data 420 input into application interface 430 in application 330 to application engine 440 at server 320. Caregiver device 150 may undergo authentication using authentication system 450 and device registration engine 460 to communicate with server 320 through application 330. Server 320 may house database 360, which may include whitelisting database 470, caregiver database 480, and customer database 490.

In some embodiments, database 360 may store information relating to caregiver 120, care receiver 110, vendors, and transactions. In some embodiments, database 360 may be accessed to perform operations consistent with disclosed embodiments. Database 360 may include vendor information for vendor(s) (e.g. vendor 130), user preferences for each of the vendor(s), and a vendor whitelist associated with the vendor information and the user preferences. The vendor whitelist may be stored in whitelisting database 470. User preferences may be stored in caregiver database 480 or customer database 490. In some embodiments, the vendor whitelist, and user preferences may be stored on the same database. For example, database 360 may be a single database storing the different types of information (e.g., vendor, user, etc.), or database 360 may be a combination of different databases (e.g., whitelisting database 470, caregiver database 480, customer database 490). User preferences may be any choices, settings, or configurations that are affiliated with caregiver 120 or care receiver 110. For example, care receiver 110 may exhibit a pattern of shopping often at a particular vendor 130 and this may be stored as a user preference in customer database 490. In another example, caregiver 120 may input or select specific transaction information or vendor information, and this information may be stored as a user preference in caregiver database 480. In some embodiments, the user preferences are associated with caregiver 120 and care receiver 110. User preferences may be any combination of preferences or information associated with caregiver 120 or care receiver 110. Vendor information may be any data that identifies or characterizes vendor 130. In some embodiments, vendor information is stored in a separate vendor database affiliated with server 320. Accessing database 360 may involve determining which databases store which information and making available the stored data or providing the data for further use. Data may temporarily be stored in memory 350 and moved, used, or processed by processor 340.

In some embodiments, caregiver database 480 may be updated with user information provided by caregiver 120. In some embodiments, customer database 490 may be updated with user information provided by caregiver 120. Customer database 490 may include a customer history. User information may be any data associated with an individual (e.g. care receiver 110 or caregiver 120). User information may include personal information (e.g. name, address, etc.), account information (e.g. user identification, username, password, etc.), user preferences, behavioral data collected by server 320, location information (e.g. GPS coordinates), device information, etc. Behavioral data may be information that characterizes or encompasses a user's actions or patterns. Customer history may be a record of activity affiliated with care receiver 110. Customer history may include past transactions at vendors (e.g. vendor 130).

In some embodiments, whitelisting database 470 may be updated based on input from caregiver 120 for vendor 130 or transaction 140. Whitelisting database 470 may include a plurality of vendors and information for a plurality of transactions. In some embodiments, the plurality of vendors may be stored on a vendor database (not shown). Updating may refer to modifying, adding, or deleting data within database 360. Updating information may be done by caregiver 120 through application 330 or automatically by server 320 according to rules established by caregiver 120. For example, caregiver 120 may input into application 330 vendor 130 with a particular transaction limit. In this example, whitelisting database 470 may find data for vendor 130 and add or modify a transaction limit associated with vendor 130. In another example, a new vendor may be input by caregiver 120 into application 330, and whitelisting database 470 may add a new data entry for vendor 130. In yet another example, caregiver 120 may wish to remove vendor 130 from the whitelist, and vendor 130 may be removed from the whitelist stored on whitelisting database 470 or the whitelist may be updated to change permissions for vendor 130 or transaction 140.

Application 330 may receive application data 420 from POS device 410. Application data 420 may include analytics data, configuration data (e.g. settings, date, time, etc.), or any metadata related to POS device 410 or transaction 140. Metadata may be data that provides information about other data. Metadata may describe various aspects of the data, such as data structure, content, context, and characteristics, to facilitate understanding, management, and use of the data. Application data 420 may also include information related to caregiver device 150 or application 330.

In some embodiments, application 330 may include application interface 430 and application engine 440. Application interface 430 may be a bridge between software program and users. Application interface 430 may be an application programming interface (API), user interface (UI), or a combination thereof. UI may be a text-based input (e.g. command line in a program), or a GUI, as described previously. An API may be a way for two computer programs or computer devices to interface. A computer device may include server 320, caregiver device 150, a care receiver device, or any device or component operating computer programs or software. In some embodiments, an API may operate to perform its communications in the background, allowing background processing, which may be any operations that happen without user (e.g. caregiver 120 or care receiver 110) input. For example, a user may be aware that background processing is allowed, but when communication happens through background processing, the user may not be aware of the communication while it occurs. For example, caregiver 120 may give permission through caregiver device 150 or application 330 to enable background processing, and information may be automatically exchanged in the background while caregiver 120 or care receiver 110 performs other functions not related to operating application 330. Allowing an API to perform background processing may be advantageous, as operating in the background may allow the API to perform its functions faster and more efficiently.

Application engine 440 may be the server-side framework or software for running application 330. Application engine 440 may include features for data management, workflow automation, business rules enforcement, and integration with other systems associated with server 320. Application engine 440 may include features for handling hypertext transfer protocol (HTTP) or hypertext transfer protocol secure (HTTPS) requests, managing user sessions (e.g. in application 330), interacting with databases, and rendering web pages or APIs (i.e. for application interface 430). In some embodiments, application engine 440 may engage with database 360.

In some embodiments, application engine 440 may engage with device registration engine 460 in server 320. Device registration engine 460 may be a software component that facilitates the registration or management of devices in a network (e.g. server 320). Device registration engine 460 may include device identification, authentication, authorization, integration (e.g. with other components of server 320), and monitoring. Device registration engine 460 may register caregiver device 150 in server 320 or application 330, and maintain a record of use of caregiver device 150 with application 330. The record of use may include date and time, device identification information, caregiver 120 information, or associated care receiver 110 information. Authentication may be any method of receiving information from a person and comparing the received information to stored information relating to identification of the person. In some embodiments, device registration engine 460 may use authentication system 450 or service. In some embodiments, authentication system 450 may be used to authenticate caregiver device 150. Authenticating caregiver device 150 may be ensuring that caregiver device 150 is truly caregiver device 150 or is operated by caregiver 120. Authentication system 450 may be a system to authenticate a user device or user's identity (e.g. caregiver 120). For example, when a device connects to server 320, device credentials may be provided to server authentication system 450. Device credentials may include certificates, device ID, tokens, etc. A token may be a unique key for a device, application, or combination thereof. Authentication system 450 may compare the credentials to a database storing credential information (e.g. an authentication database). Authentication system 450 may be run by server 320, phone call, text message, email, or a third-party service (e.g. Google Authenticator™, Duo™, Okta™, etc.). Authentication system 450 may use: a password-based authentication using login information (e.g. username and password); a certificate-based authentication identifying caregiver device 150 based on a certificate certified by a trusted certificate authority or media access control (MAC) address authentication; token-based authentication; two-factor authentication; openID authentication (e.g., third-party). Caregiver 120 may be given the choice whether to use authentication system 450.

In some embodiments, the server may communicate with a device inputting information associated with vendor information or user preferences. The input may be received from caregiver 120 through caregiver device 150. The input may include any combination of vendor information or user preferences. The communication may involve network 160 and include any combination of physical connection, wireless connection, network connection, Internet connection, or connection through application 330. Inputting information may involve storing the input in database 360 or memory 250. The device may be caregiver device 150.

In some embodiments, the server may receive input from a device, including approved vendors or disapproved vendors. An approved vendor may include any vendor to be included in a vendor whitelist associated with whitelisting database 470. A disapproved vendor may include any vendor to be included in a denylist or excluded from the vendor whitelist. In some embodiments, the vendor whitelist may include reference to disapproved vendors or a denylist. For example, the vendor whitelist may include the name of a denylist stored on database 360 for vendors similar to an approved vendor but that are disapproved vendors.

In some embodiments, a vendor whitelist corresponding to input information may be updated. The input information may be provided by caregiver 120 using caregiver device 150. The input information may include at least one approved vendor or at least one disapproved vendor, or a reference to a list of approved vendors or a list of disapproved vendors. The vendor whitelist may be stored on whitelisting database 470. For example, an approved vendor may be added to the vendor whitelist in whitelisting database 470, while a disapproved vendor may be removed from the vendor whitelist. The vendor whitelist may be used by server 320 to allow or block transaction 140.

In some embodiments, an approval for transaction request 425 to a second device may be provided if vendor 130 is on the vendor whitelist. The second device may be a smartphone operated by care receiver 110 or POS device 410. Transaction request 425 may be a communication sent by POS device 410 to initiate transaction 140. For example, if care receiver 110 attempts to make a purchase, care receiver 110 may swipe a credit card at a card reader operating as POS device 410, and the card reader may send transaction request 425 to server 320 to initiate transaction 140. Various security protocols may be implemented during transaction request 425 to protect personal or financial information associated with care receiver 110. Security protocols may include card microchips, data security standards, encryption, tokenization of data, and authentication methods (e.g. similar to authentication system 450). Tokenization of data may refer to replacing sensitive cardholder data, such as account numbers, with unique tokens that have no intrinsic value and cannot be used for fraudulent purposes.

In some embodiments, transaction request 425 may be automatically allowed or disallowed for vendor 130 in permissions. Permissions may be a vendor whitelist and may be stored in a database. Permissions may be rules that define what access care receiver 110 has to transaction 140 at vendor 130. For example, server 320 may receive transaction request 425 from POS device 410 at vendor 130 on the vendor whitelist, and transaction 140 may be approved automatically without any input from caregiver device 150. In another example, transaction 140 may be disallowed by server 320 automatically even though vendor 130 is in the vendor whitelist, because transaction 140 was too high and deemed to be a risk. In some embodiments, the automatic approval or disapproval may be accomplished by allowing caregiver 120 to select or deselect such automation in application 330. In some embodiments, caregiver 120 may select a global transaction limit for all transactions by care receiver 110. A global transaction limit may be the highest amount for transaction 140 that care receiver 110 can make for any transaction at any vendor. If transaction 140 is greater than the global transaction limit, transaction 140 may be disallowed.

In some embodiments, an approval of transaction 140 may be provided if a transaction cost associated with transaction request 425 is at or below a predetermined transaction threshold. The predetermined transaction threshold may be determined or established by caregiver 120. For example, caregiver 120 may know a limit for transaction totals at a particular vendor for care receiver 110 and establish the predetermined transaction threshold. A transaction cost may be the purchase amount that is included in transaction request 425 for transaction 140. A transaction threshold may be a purchase limit for the transaction cost. The transaction threshold may be provided by caregiver 120 for each vendor of a plurality of vendors, for categories of vendors, or as a global transaction limit. The transaction threshold may be any amount for any vendor. For example, a transaction threshold of $200 may be set for vendor 130 at which care receiver 110 wishes to make transaction 140, and if vendor 130 is on the vendor whitelist, but transaction 140 amounts to $201, transaction 140 may be disallowed (i.e. prevented, declined, blocked, or denied). A notification of this disallowed transaction may be sent to the vendor or POS device 410 and displayed to care receiver 110 or sent to caregiver device 150 through application 330.

In some embodiments, the approved vendor, the disapproved vendor, and the transaction threshold may be stored in database 360. These may be stored together (e.g. in a tabular form with rows and columns) in database 360, or they may be stored separately in database 360. For example, the approved vendor, disapproved vendor, and transaction threshold may be stored in a table in caregiver database 480 or whitelisting database 470, or both. Application 330 may then have access to that stored information to process transaction 140.

In some embodiments, the vendor whitelist may include at least one approved category of vendors. If vendor 130 is in the approved category of vendors, transaction request 425 may be approved. The approval may be done automatically by server 320 if transaction 140 occurs at vendor 130 on the vendor whitelist. By enabling caregiver 120 to provide approval via a category of vendors, rather than only individual vendors, efficiency may be improved. In some embodiments, a transaction threshold provided by caregiver 120 may be applied to a category of vendors. For example, caregiver 120 may choose a particular transaction threshold for a category of vendors, and if transaction 140 goes above the transaction threshold for vendor 130 in the category of vendors, then transaction 140 may be disallowed.

In some embodiments, a new transaction request may be made at a new vendor not on the permissions or whitelist. Whether to approve or disapprove the new transaction request may be automatically determined based on characteristics of the new vendor or the new transaction request. The permissions may be associated with whitelist information 310, including the vendor whitelist. A new transaction request at a new vendor may occur when care receiver 110 attempts to make a purchase at a vendor for which there may be no previous data available on database 360. Automatically determining whether to approve or disapprove the new transaction request may involve an analysis, categorization, or prediction of characteristics that describe a new vendor or a new transaction. The analysis may include identifying vendor information for the new vendor, determining the category of vendor for the new vendor based on the vendor information, and assessing whether the new vendor is one that may be allowed by caregiver 120. For example, if a category is identified for the new vendor, then the category of vendors may be used to approve or disapprove of the transaction, based on the vendor whitelist. In another example, vendor location information may be used to determine whether to approve or disapprove of the new transaction.

In some embodiments, automatically determining whether to approve or disapprove a transaction may include using at least one of: time series analysis, exponential smoothing, seasonal decomposition of time series, or Bayesian statistics. Such metrics may be general mathematical approaches useful to interpolate, extrapolate, or predict information that may be useful in making automated decisions based on previous information.

In some embodiments, a machine learning model may be trained on previous transaction information and used to make a prediction for the new transaction request. A machine learning model may be a model trained on a dataset to make predictions or decision based on new input data. A machine learning model may include linear regression, logistic regression, decision trees, random forests, artificial intelligence (AI), support vector machines, neural networks, K-nearest neighbors, clustering algorithms etc. Training the model may be using a training dataset to learn relationships between the inputs and outputs of the machine learning model to improve performance and minimize errors in predictions. Training the model may include using previous transaction information, such as any previous transactions made at a plurality of vendors, and the like, to improve the prediction of whether to approve or disapprove transaction 140. Previous transaction information may come from a plurality of care receivers or a plurality of caregivers, or some combination thereof.

In some embodiments, the previous transaction information may include a type of vendor, vendor location, or location of care receiver 110. Type of vendor may be the same as a category of vendors. Type of vendor may include retail vendors, wholesale vendors, manufacturers, service providers, online vendors, local vendors, franchise vendors, etc. A machine learning model may predict whether to approve or disapprove of a transaction based on the type of vendor or vendor location. For example, if care receiver 110 is shopping at a new vendor, the type and location of vendor 130 may be used to predict whether caregiver 120 might approve or disapprove of transaction 140 and the approval or disapproval may be provided to POS device 410.

In some embodiments, a denylist of unacceptable vendors for which the transaction request is denied may be generated. The denylist may be generated automatically using predictions from the machine learning model. The denylist may also be generated by input from caregiver 120. In some embodiments, the denylist may include at least one disapproved category of vendors. If vendor 130 is in the disapproved category of vendors, transaction request 425 may be denied. Similar to an approved category of vendors, a disapproved category of vendors may be any category of vendors for which transaction 140 is disallowed.

In some embodiments, a card scoring system may be used to evaluate risk of fraud during transaction 140. For example, during transaction request 425, POS device 410 may send card information to a card scoring system. A card scoring system may be a system to evaluate and rank a card (e.g., credit card or debit card) based on risks and benefits during transactions. In some embodiments, the card scoring system includes two steps: a first step involving an external institution maintaining a flow of financial information (e.g., VISA™, Mastercard™, American Express™, Discover™, etc.), and a second step involving an institution operating the card. Such a two-step method may enhance fraud prevention during transaction 140. The second step may include using any of database 360 storing information relating to caregiver 120, care receiver 110, vendor 130, or whitelist information 310. The card scoring system may be used to help server 330 to decide whether to automatically approve or block transaction 140.

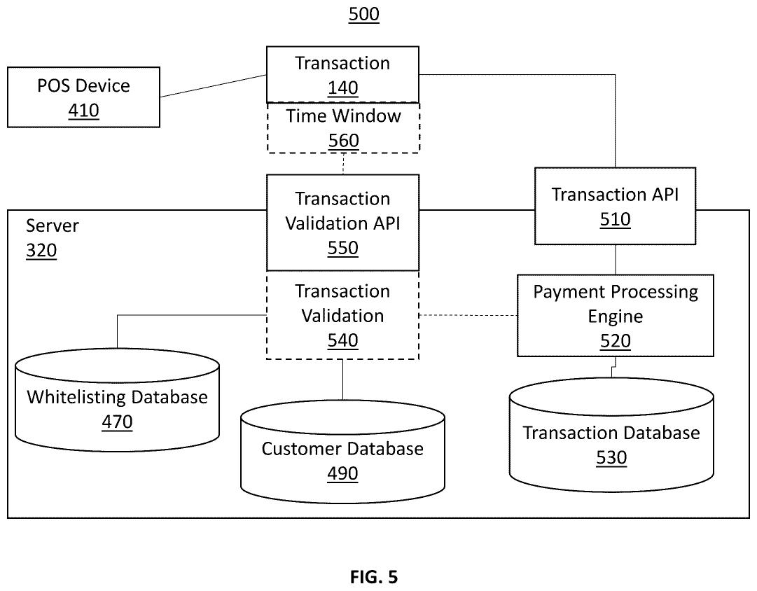

FIG. 5 shows example system environment 500 for enabling or disabling transaction 140 at POS device 410 using the whitelist, consistent with the disclosed embodiments. Transaction 140 may communicate with server 320 through transaction API 510. Transaction API 510 may engage payment processing engine 520, which may exchange and store data in transaction database 530. Server 320 may use information from payment processing engine 520 to initiate transaction validation 540, which may use information from database 360. Transaction validation 540 may communicate with POS device 410 through transaction validation API 550. Time window 560 may be implemented between transaction validation 540 and approval or disapproval of transaction 140.

When initiated by POS device 410, an attempt to make transaction 140 may be communicated through transaction API 510 to server 320. Transaction API 510 may be an API that works to communicate information related to transaction 140 and server 320. Transaction API may communicate through payment processing engine 520. Payment processing engine 520 may be a software system designed to handle the processing of information needed to facilitate the exchange of financial information related to transaction 140. Payment processing engine 520 may be a part of server 320, as in FIG. 4, or payment processing engine 520 may be a separate system configured to engage with server 320.

Information related to transaction 140 and any past transactions made through POS device 410 or other devices used to make any transaction at any vendor may be stored in transaction database 530. The transaction information may be stored in transaction database 530 by payment processing engine 520 or transaction API 510. The transaction information may be later accessed and used for future analyses, predictions, or other use. Transaction database 530 may be a database (e.g. database 360) that stores information related to transaction 140 or past transactions that occurred before transaction 140. Past transactions may form a transaction history that can be used to perform analyses or make predictions regarding future transactions. For example, such predictions may indicate general trends of transactions over time by care receiver 110 at vendors like vendor 130.

Approval or disapproval of transaction 140 may occur through transaction validation API 550. Transaction validation API 550 may be any API performing operations related to validation for transaction 140. Validation may refer to a process of ensuring that a set of rules or a criterion is met. Transaction validation API 550 may use information from whitelisting database 470, customer database 490, or transaction database 530 to compare to information POS device 410 regarding transaction 140. Resourcing information from these databases may allow for a comparison of information related to past and present transactions, information from caregiver 120 regarding vendor whitelist, information associated with care receiver 110, etc.

In some embodiments, time window 560 may be used to introduce a delay in waiting for an approval or disapproval of transaction 140. Time window 560 may be any period of time during which transaction 140 may not be blocked as POS device 410 awaits further instructions. For example, during time window 560, transaction 140 may be paused to allow server 320 to provide an approval or disapproval of transaction 140. In some embodiments, time window 560 may be introduced by server 320 to provide sufficient time for approval or disapproval of transaction 140 to be determined. In some other embodiments, time window 560 may be based on some metric associated with a delay in receiving an approval or disapproval from server 320. For example, the delay may be computational processing time or signaling delays associated with the time it takes communication to travel through network 160. By accounting for or providing time window 560, server 320 may be provided with time sufficient to make an analysis of transaction 140 and determine whether transaction 140 should be approved or disapproved. Time window 560 may be beneficial to provide a designated delay to await a reply from server 320. For example, if such a reply were to not come within time window 560, server 320 or POS device 410 may provide an error accompanied by an error message (e.g. incomplete transaction message). After such an error occurs retransmission of information related to transaction 140 may occur, or a request to retry transaction 140 may be provided to POS device 410.

In some embodiments, approval or denial of transaction request 425 may occur in real time, within a predetermined time duration. Real time may refer to a response to input with minimal delay. The predetermined time duration may be a small amount of time used for relaying signals through network 160 and processing information on devices or servers. The predetermined time duration may be time window 560 or an additional time duration independent of time window 560. The predetermined time duration may be determined by POS device 410 or server 320 based on the typical time duration required to communicate through network 160 to reach a decision regarding transaction 140.

In some embodiments, automatic approval or declining transaction request 425 may occur based on caregiver 120 previous decision for a previous transaction. This automatic approval or declining of transaction request 425 may occur for a second predetermined time duration. A previous decision for a previous transaction may be any decision caregiver 120 made for a previous transaction occurring at vendor 130. The second predetermined time duration may be a duration of time during which server 330 does not request feedback from caregiver 120 on transaction 140. The second predetermined time duration may be a set duration for each vendor or each transaction such that a financial institution provides automatic approval when a previous approval has been made. Alternatively, the second predetermined time duration may be a variable duration for each vendor or each transaction and selectable by caregiver 120 or a financial institution.

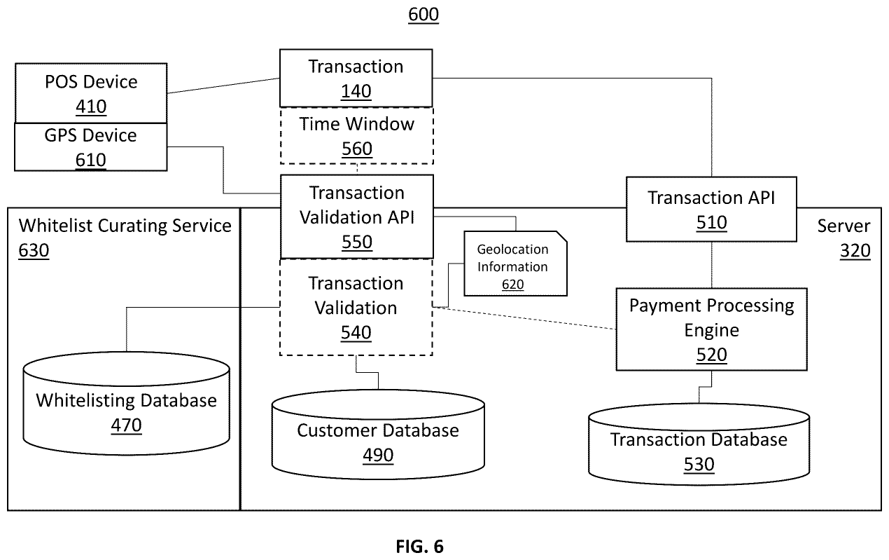

FIG. 6 shows example system environment 600 for enabling or disabling transaction 140 at POS device 410 using location and the whitelist, consistent with the disclosed embodiments. POS device may be associated with a global positioning system (GPS) or global navigation satellite system (GNSS) through GPS device 610. Transaction 140 with time window 560 may communicate with server 320 through transaction validation API 550 or transaction API 510. Payment processing engine 520 may engage server 320 for transaction validation 540 using transaction database 530, customer database 490, and whitelisting database 470, using geolocation information 620. Whitelisting database 470 may be operated by whitelist curating service 630.

In some embodiments, a GNSS system may be used to establish the location of care receiver 110 or location of transaction 140. A GNSS system may refer to any satellite navigation or location system that provides geo-spatial positioning or location information. GNSS may include global positioning system (GPS), global navigation satellite system (GLONASS), Galileo, BeiDou, etc. Establishing location information may include extracting information from a device configured to utilize GNSS. For example, POS device 410 may be configured to engage with or contain within it GPS device 610. GPS device 610 may be any device or components of a device compatible with or configured to communicate with GNSS operating systems.

In some embodiments, permissions or whitelist information 310 may include a geolocation for vendor 130. Permissions may be whitelist or denylist stored in database 360. Information relating to a geolocation may be stored in a way that allows association between vendor 130, caregiver device 150, or care receiver 110. For example, information identifying vendor 130 and vendor location may be stored together, along with other information including whitelisting information 310, in a table including rows and columns.

The location or geolocation of care receiver 110, POS device 410, or vendor 130 may be valuable for determining whether transaction 140 should be approved. In some embodiments, caregiver device 150 provides approval or disapproval of transaction request 425 based on the location information (e.g. geolocation information 620). Location established by GPS device 610, or vendor location, may be used to identify the location information used for this approval or disapproval. This location information may be provided to caregiver 120. For example, during transaction 140, vendor location may be provided to caregiver 120 on caregiver device 150, and caregiver 120 may provide approval or disapproval of transaction 140. Caregiver 120 may establish protocols based on location and vendor information. These protocols may be stored in database 360 (e.g. any of whitelisting database 470, customer database 490, or transaction database 530).

In some embodiments, server 320 may be configured to approve a transaction request (e.g. transaction 140) based on the location information. Server 320 may use geolocation information 620 to determine, through transaction validation 540, whether to approve or disapprove transaction 140. In some embodiments, approval or disapproval of transaction 140 may be automatic. For example, caregiver 120 may establish a protocol for care receiver 110 that automatically prevents transaction approval for any transaction in a particular postal code. In another example, care receiver 110 may initiate transaction 140 from a particular location, and server 320 may use geolocation information 620 to approve transaction 140 if transaction 140 is below a transaction cost threshold. Such automation could occur even if server 320 expects a response from caregiver device 150. For example, server 320 may determine approval or disapproval of transaction 140 after a predetermined duration of time passes. This automation may provide caregiver 120 comfort in knowing that even if caregiver 120 is not available to respond to a communication, transaction 140 may be handled appropriately based on pre-established protocols, such as location information.

In some embodiments, whitelisting database 470 may be located on a third-party server. A third-party server may be any server not associated with the general functions of server 320. For example, a third-party server may be located and maintained by a different entity than server 320, such as a whitelist curating service 630. A whitelist curating service may specialize in screening, storing, and predicting whitelist information 310 for a whitelist or permissions associated with transaction 140. In some embodiments, whitelisting may be provided as a service, such as an entity that curates known good stores (e.g., grocery stores, pharmacies, gas stations, convenience stores). For example, an optional service may be provided where caregiver 120 need not manage the locations entirely, but instead relies on geolocating care receiver 110 and automatically accepts a reasonable transaction amount, based on a threshold, for purchases at known good stores within a distance of the home of care receiver 110 or caregiver 120. For example, when on vacation, care receiver 110 may upload a new geolocation point to measure from, so, for example, if care receiver 110 is at a hotel, they can shop at the hotel store within the preestablished distance limits/boundaries.

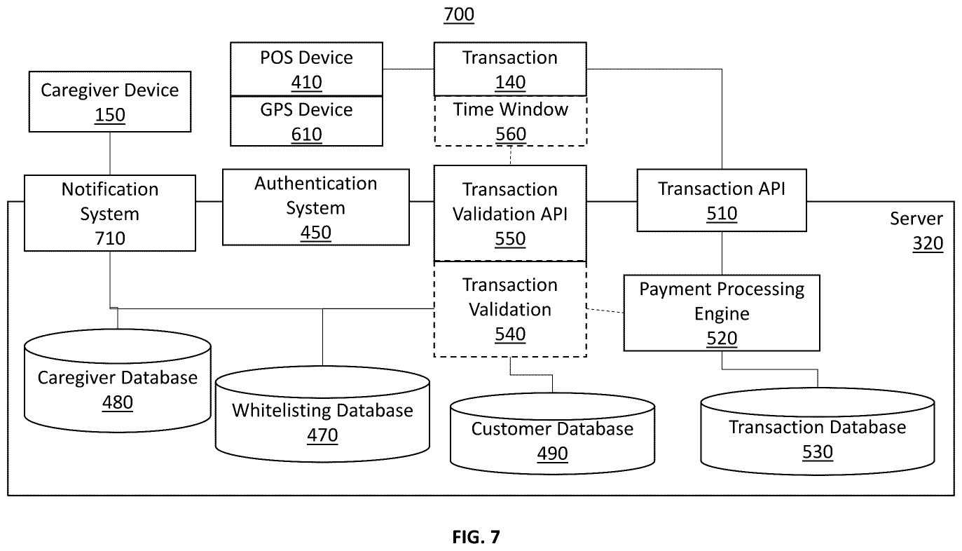

FIG. 7 shows example system environment 700 for providing a notification to caregiver 120, consistent with the disclosed embodiments. FIG. 6 incorporates many elements and components of FIGS. 2 to 5. Upon receipt of a request for transaction 140, server 320 may provide a notification to caregiver 120 using notification system 710. Caregiver 120 may communicate approval or disapproval of transaction 140.

In some embodiments, notification system 710 in server 320 may be used to provide a communication with caregiver device 150. A communication may be a notification, text message, email, or phone call on caregiver device 150. Caregiver 120 may then be provided with an option to approve or disapprove of transaction 140, providing control over purchases made by care receiver 110. Notification system 710 may be configured to provide a communication with caregiver 120 with or without the expectation of feedback from caregiver 120. A communication without the expectation of feedback may simply be a message informing caregiver 120 that transaction 140 has taken place.

In some embodiments, notification system 710 may provide a communication seeking approval or disapproval via an application accessed by caregiver device 150. A communication may be a message relayed to a user. In some embodiments, a communication may include a notification on caregiver device 150, an automated phone call, a phone call from an employee of vendor 130 or financial institution, a text message, etc. For example, a communication could be a notification that appears on the screen of caregiver device 150, asking caregiver 120 to select ‘approve’ or ‘disapprove’. In some embodiments, notification system 710 receives approval or disapproval of transaction request 425 from caregiver device 150 or application 330. Caregiver 120 may input a selection of approval or disapproval through a user interface on caregiver device 150. For example, the selection may be input or made using buttons, icons, text, voice, etc.

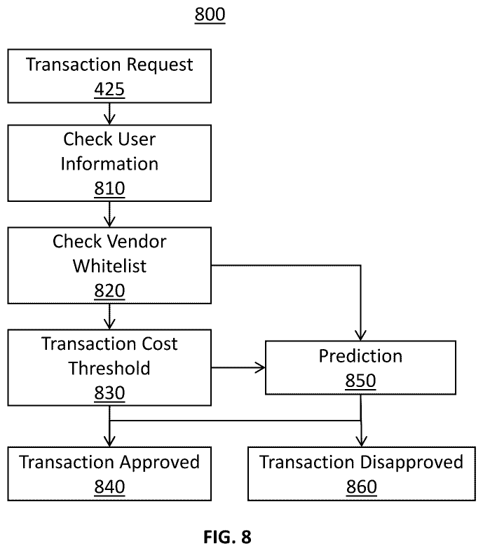

FIG. 8 shows example process 800 for approving or disapproving transaction 140, consistent with the disclosed embodiments. FIG. 8 incorporates elements from FIGS. 1 to 7. When care receiver 110 makes transaction request 425, a step may be performed to check user information 810 to identify the relevant user information in database 360. Information associated with transaction 140 may be sent to server 320, where approval may be sought. Vendor whitelist 710 may have received input from caregiver device 150 and may be stored in server 320. Server 320 may check vendor whitelist 820 to determine if vendor 130 at which transaction 140 is taking place is on vendor whitelist 710 for automatic approval. If vendor 130 is on vendor whitelist 710, then server 320 may determine whether a cost associated with transaction request 425 is below transaction cost threshold 830. If the cost is below transaction cost threshold 830, then the result may be transaction approved 840.

In process 800, if either vendor 130 is not on vendor whitelist 710 or the cost associated with transaction request 425 is above transaction cost threshold 830, or both, then server 320 may use prediction 850 to attempt to determine the appropriate course of action. For example, prediction 850 may be used when a new transaction at a new vendor is initiated by care receiver 110. In such a scenario, prediction 850 may use machine learning models, as described previously, to determine if the new vendor may be associated with vendor whitelist 710, if the cost of the transaction may be acceptable, or some combination thereof. The result of prediction 850 may be transaction approved 840 or transaction disapproved 860. In some embodiments, transaction disapproved 860 may occur without prediction 850. For example, transaction disapprove 860 may occur when check vendor whitelist 820 or transaction cost threshold 830 conditions are not met.

In some situations, a split payment may occur to attempt to thwart transaction cost threshold 830 of caregiver 120. For example, a fraudster may try to convince care receiver 110 to split payment to two or more methods, and in such a scenario server 320 may detect if the sum of these methods adds up to transaction cost threshold 830 and inform caregiver 120 through notification system 710, or outright reject the transactions automatically. Time window 560 may be useful for obtaining transaction approved 840 in this case. Caregiver 120 may be given the opportunity to adapt time window 560 to account for this scenario.

The following are examples of implementation of the systems and methods described above. The examples are not intended to be limiting, but rather are merely used to serve as demonstrations for the point of explanation.

Example 1: in this example of implementing the above embodiments, a customer (e.g. care receiver 110) is weary of elder fraud scams and wants to ensure there are limits to the credit card activity and may apply for a whitelisting credit card. The customer may then submit a list of merchants the customer frequents on a regular basis and establishes the highest amount the customer generally spends for each. The customer may name the customer's child as a caregiver (e.g. caregiver 120), since the customer's child assists with healthcare and financial matters for the customer. For example, if the customer goes to a grocery store at the customer's usual store with a threshold of $200, and spends $56 at the checkout, then the transaction may be approved since it is a whitelisted merchant and less than the threshold. In this example, the customer voluntarily applied for the whitelisting credit card. In other cases, the customer may not voluntarily apply, but caregiver 120 may provide the whitelisting credit card. For example, caregiver 120 may be a power of attorney over care receiver 110.

Example 2: if a customer needs a new water heater and the merchant is not on the current whitelist, then the transaction may trigger a notification or call to caregiver 120 to approve or disapprove the transaction. If the caregiver is aware of the upcoming water heater purchase, then caregiver 120 may approve the transaction. The notification may include information such as vendor 130 and transaction cost.

Example 3: in this example of a fraud attempt, a customer may receive a call from someone claiming to be the customer's grandson requesting $5000 in gift cards urgently. The customer may immediately rush to a store with a limit of $200 to buy the gift cards, but the amount is higher than the threshold, so the transaction triggers a call to caregiver 120. Caregiver 120 may then recognize the fraud attempt and decline the transaction. In some cases, caregiver 120 may not be able to respond, and the transaction could remain uncompleted, or could time-out and be declined. Alternatively, caregiver 120 may give permission for server 320 to determine an appropriate response automatically based on prediction (e.g. prediction 740).

Example 4: in this example a customer goes shopping at a grocery store. Due to inflation, and lifestyle adjustments, the customer has spent increasing amounts on transactions over time, pushing the transaction costs closer to transaction cost threshold 720. When a subsequent transaction goes above transaction cost threshold 720, server 320 may recognize this trend and make prediction 740 that an approval of the subsequent transaction should be made. Server 320 may provide approval automatically, or through a communication with caregiver 120. For example, at checkout, the customer spends $205 on a purchase, which is higher than transaction cost threshold $200 for the whitelisted vendor. The last several purchases were between $175-$190 and trending up over time. Server 320 may find a trend over time that general transaction costs for the whitelisted vendor were going up by roughly the same amount that costs were increasing for the customer's transactions, so server 320 may automatically approve the transaction. In such a scenario, server 320 may notify caregiver 120 that despite the transaction cost being higher than the threshold, the transaction was approved.

In some embodiments, machine learning models, including AI, may be used to make a prediction (e.g. prediction 740) for at least one new vendor and provide a recommendation to caregiver 120 based on previous information. These methods can be used to learn from data from caregiver 120 or care receiver 110 over time. For example, caregiver 120 may be prompted that a new vendor has opened nearby that corresponds with the behavior of care receiver 110. Caregiver 120 may then be prompted to whitelist or denylist the new vendor. These predictions may also be used to automatically adjust the cost threshold (e.g. transaction cost threshold 720). For example, if the cost of goods is changing, the threshold could be adjusted automatically with or without explicit permission from caregiver 120. In another example, care receiver 110 may be spending less than the limit established by caregiver 120, and the prediction may recommend adjusting the threshold. Consistent with this embodiment, the previous information may include type of vendor or vendor location or any similar information that could help to inform the prediction. This could include an iterative process that may or may not include input from caregiver 120 or care receiver 110.

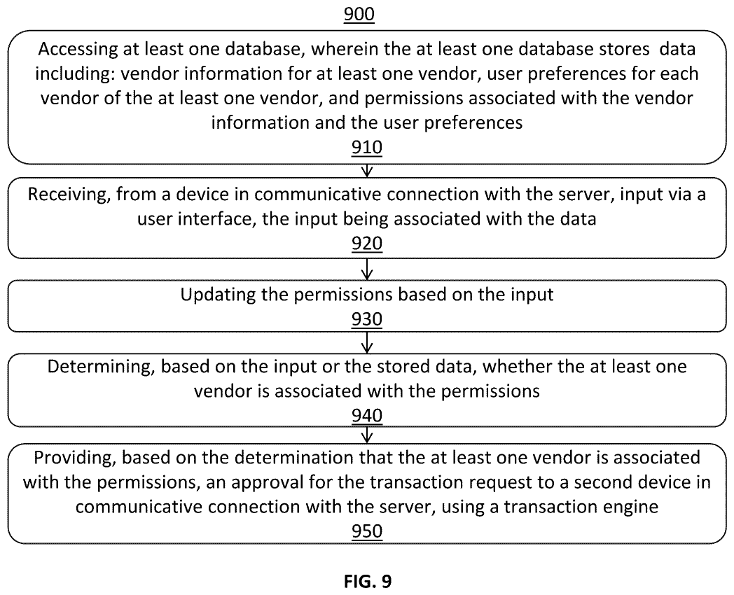

FIG. 9 shows example process 900 for authorizing a transaction request, in connection with FIGS. 3 to 8 consistent with some disclosed embodiments. Authorizing transactions initiated by a care receiver may be done automatically by a server or through selection by a caregiver responsible for the care receiver to prevent fraudulent or otherwise undesirable transactions. For example, care receiver may be a dependent person such as an elderly person with dementia and their caregiver may be responsible for that person financially. Alternatively, the care receiver may be a dependent person such the caregiver's child who is not yet trustworthy with money. Process 900 may include use of at least one database and an application operated by a server and configured to interact with a POS device or a caregiver device to authorize or block a transaction or transfer.

In step 910, process 900 may include accessing at least one database, wherein the at least one database stores data including: vendor information for at least one vendor, user preferences for each vendor of the at least one vendor, and permissions associated with the vendor information and the user preferences. The at least one database may be any combination of a whitelisting database storing whitelisting or denylisting information, a caregiver database storing caregiver information, a customer database storing care receiver shopping information, a transaction database storing information about completed or failed transactions, or any other repository of data that may be stored on a server.

In step 920, process 900 may include receiving, from a device in communicative connection with the server, input via a user interface, the input being associated with the data. The input may be any information that is related to a vendor, including vendor information. The input may be related to preferences for the customer (e.g. a care receiver), stored in a customer database, or preferences for a caregiver, stored in a caregiver database. The input may be used to update a whitelist stored on a whitelisting database.

In step 930, process 900 may include updating the permissions based on the input. Updating the permissions may include updating a vendor whitelist, which may include adding vendor information to the whitelist, editing the information, or deleting any information related to a vendor. For example, a caregiver may add a new vendor to the vendor whitelist, along with a threshold for a transaction cost, and this information may be stored in a whitelisting database.

In step 940, process 900 may include determining, based on the input or the stored data, whether the at least one vendor is associated with the permissions. For example, this determining step may include a server searching a whitelist in a whitelisting database for permissions associated with care receiver making a purchase at a vendor, and server may determine whether to allow or block the purchase based on the permissions.

In step 950, process 900 may include providing, based on the determination that the at least one vendor is associated with the permissions, an approval for the transaction request to a second device in communicative connection with the server, using a transaction engine. A server may identify information associated with a vendor during a transaction and find the vendor on the vendor whitelist, resulting in an approval of the transaction.

In process 900, steps 940 and 950 may present a binary method to allow or block a transaction, or the steps may include use of a scoring system in which a card or a transaction are scored to determine whether to approve or block a transaction. A fraud system may be used to determine whether fraud has occurred based on the score or some other metric, such as identification information, geolocation, etc.

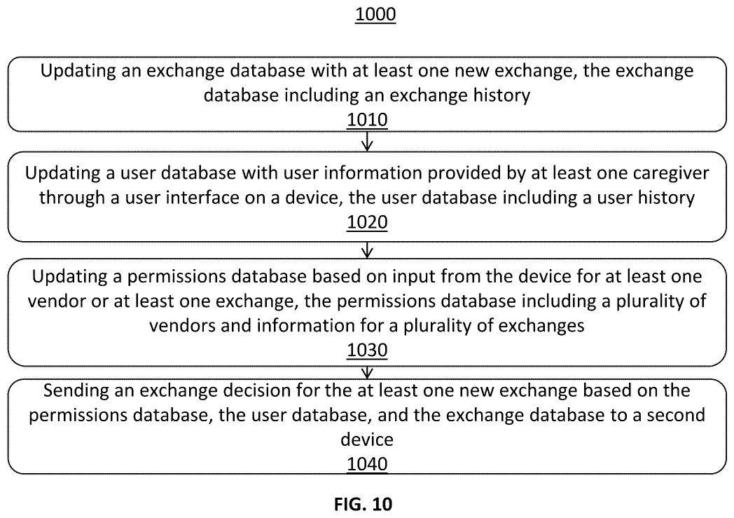

FIG. 10 shows example process 1000 for updating information associated with exchanges in connection with FIGS. 3 to 8 consistent with some disclosed embodiments. Updating information may include updating data in at least one database, including, a whitelisting database, a caregiver database, a customer database, or a transaction database. The updated information may include an updated whitelist used to allow or block a transaction for a care receiver.

In step 1010, process 1000 may include updating an exchange database with at least one new exchange, the exchange database including an exchange history. An exchange may be a transfer or transaction. The exchange database may be a transaction database. An exchange history may be a transaction history and may include any current or previous transaction associated with a care receiver. Updating the exchange database may include adding, amending, or deleting any information associated with current or previous transactions. For example, an exchange database may be a transaction database and when a new transaction is added, a combination of the new transaction information with the previous transaction information may be used to enhance a prediction of allowing or blocking an exchange. Predicting may include using machine learning models to predict the outcome of any future transactions.

In step 1020, process 1000 may include updating a user database with user information provided by at least one caregiver through a user interface on a device, the user database including a user history. A caregiver may provide user information through a user interface, and the user information may be related to the caregiver or a care receiver under care of the caregiver. The user database may be a customer database or a caregiver database, where the user information refers to information already stored in the database. For example, a caregiver may input into a user interface user information related to a care receiver, and this user information may be stored in a customer database, where it may be accessed by a server and used to analyze information associated with a requested exchange or transaction.

In step 1030, process 1000 may include updating a permissions database based on input from the device for at least one vendor or at least one exchange, the permissions database including a plurality of vendors and information for a plurality of exchanges. Permissions may be information associated with allowing or blocking transactions or exchanges, including a whitelist or a denylist. A permissions database may be a whitelisting database. For example, a caregiver may input information related to permissions for a vendor such that a server may whitelist a transaction at the vendor based on the information.

In step 1040, process 1000 may include sending an exchange decision for the at least one new exchange based on the permissions database, the user database, and the exchange database to a second device. For example, a POS device may send a transaction request or exchange request, and a server may use information in a whitelisting database, a customer database, and an exchange database to result in an approval of the exchange, and this decision may be sent to POS device to allow the exchange or transaction. The exchange decision may include use of a notification system to alert a caregiver of the decision, or to allow the caregiver to make a final decision. The final decision could be immediate via a prompt, phone call, or some other means by which immediate feedback is requested, or the final decision could allow a delay in the response from the caregiver.

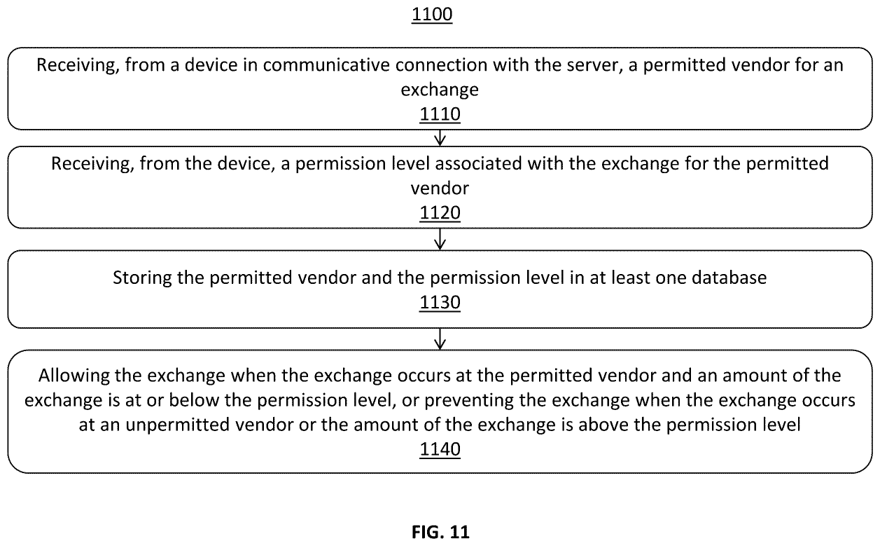

FIG. 11 shows example process 1100 for determining an attempted exchange, as described above in connection with FIGS. 3 to 8, consistent with some disclosed embodiments. An attempted exchange may be a transaction request. For example, threshold associated with a transaction cost may be used to approve or block an exchange or transaction.

In step 1110, process 1100 may include receiving, from a device in communicative connection with the server, a permitted vendor for an exchange. For example, a caregiver device may communicate with a server to provide a permitted vendor to add to a vendor whitelist or a denylist of disapproved vendors. Input may be provided through a user interface.

In step 1120, process 1100 may include receiving, from the device, a permission level associated with the exchange for the permitted vendor. For example, a caregiver device may provide, from a caregiver, a permission level or threshold for a transaction cost associated with a transaction for a vendor.

In step 1130, process 1100 may include storing the permitted vendor and the permission level in at least one database, and the transaction threshold in at least one database. The at least one database may be a whitelisting database, a customer database, a transaction database, or a caregiver database. For example, vendor information for a permitted vendor or a permission level may be stored in any database in a server to be later accessed by the server.

In step 1140, process 1100 may include allowing the exchange when the exchange occurs at the permitted vendor and an amount of the exchange is at or below the permission level, or preventing the exchange when the exchange occurs at an unpermitted vendor or the amount of the exchange is above the permission level. For example, as depicted in FIG. 8, if a transaction is associated with a transaction request at a permitted vendor on a vendor whitelist and below a transaction cost threshold (or permission level), then a server may allow the transaction. In another example, if a transaction request includes a transaction at a vendor not on vendor whitelist (e.g., an unpermitted vendor) or above a permission level, then the server may block the transaction. Alternatively, machine learning models may be used predict the outcome for a transaction based on a transaction history.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is to be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1-22. (canceled)

23-42. (canceled)

43. A system for determining an attempted exchange, the system comprising a server with at least one processor, the at least one processor configured to:
receive, from a first device in communicative connection with the server, permitted vendor data for an exchange;
receive, from the first device, a permission threshold associated with the exchange;
store the permitted vendor and the permission threshold in at least one database;
receive, from a second device, an indication of the exchange for a vendor; and either:
send, if an amount of the exchange is equal to or less than the permission threshold, an approval signal to the second device;
send, if the amount of the exchange is above the permission threshold, a disapproval signal to the second device; or
prevent the exchange when the exchange occurs at an unpermitted vendor.

44. The system of claim 43, wherein the processor is further configured to restrict access of the second device to the permitted vendor data, wherein the first device is operated by a caregiver to send the exchange data to the server, and the second device is utilized by a care receiver during the exchange.

45. The system of claim 44, wherein the processor is further configured to receive a permitted vendor request or a permission threshold request from the care receiver via the second device.

46. The system of claim 43, wherein the processor is further configured to operate a notification system configured to provide a communication requesting an approval or a disapproval of the exchange via an application accessed by the first device.

47. The system of claim 46, wherein the notification system is configured to receive the approval or the disapproval of the exchange from the application accessed by the first device.

48. The system of claim 43, wherein the processor is further configured to generate or update a denylist including the unpermitted vendor for which the exchange is automatically prevented.

49. The system of claim 48, wherein the denylist includes at least one disapproved category of vendors, wherein if the vendor is in the disapproved category of vendors, the exchange is automatically prevented.

50. The system of claim 48, wherein the processor is further configured to prevent the exchange during the exchange within a predetermined time duration.

51. The system of claim 43, wherein the processor is further configured to send the approval signal during the exchange within a predetermined time duration.

52. The system of claim 43, wherein the processor is further configured to:
store a geolocation of the permitted vendor or the unpermitted vendor in at least one database associated with the server; and
receive a geolocation of the second device.

53. The system of claim 52, wherein the processor is further configured to provide the approval signal automatically based on the geolocation of the second device.

54. The system of claim 52, wherein the processor is further configured to provide the disapproval signal or prevent the exchange automatically based on the geolocation of the second device.

55. The system of claim 43, wherein the processor is further configured to receive a new exchange at a new vendor and automatically determine whether to send the approval signal or the disapproval signal, or prevent the exchange based on characteristics of the new vendor or the new exchange.

56. The system of claim 55, wherein the processor is further configured to determine whether to send the approval signal or the disapproval signal, or prevent the exchange based on at least one of: time series analysis, exponential smoothing, seasonal decomposition of time series, or Bayesian statistics.

57. The system of claim 55, wherein the processor is further configured to determine whether to send the approval signal or the disapproval signal, or prevent the exchange based on a machine learning model trained on previous transaction information.

58. The system of claim 55, wherein the characteristics include at least one of: type of vendor, vendor location, transaction history, or user information.

59. The system of claim 43, wherein the processor is further configured to operate an authentication system to authenticate the first device or the second device.

60. A method for determining an attempted exchange, the method comprising:
receiving, from a first device in communicative connection with the server with at least one processor, permitted vendor data for an exchange;
receiving, from the first device, a permission threshold associated with the exchange;
storing the permitted vendor and the permission threshold in at least one database;
receive, from a second device, an indication of the exchange for a vendor; and either:
sending, if an amount of the exchange is equal to or less than the permission threshold, an approval signal to the second device;
sending, if the amount of the exchange is above the permission threshold, a disapproval signal to the second device; or
preventing the exchange if the exchange occurs at an unpermitted vendor.

61. The system of claim 43, wherein the processor is further configured to store a record of the exchange in an audit database associated with the server, the record comprising at least one of: a timestamp, a vendor identifier, an exchange amount, a device identifier, or an exchange outcome.

62. The system of claim 43, wherein the processor is further configured to apply a permission threshold adjustment, based on at least one of: an exchange history, caregiver-defined rules, a time of day of the exchange, or a vendor category, automatically to modify the permission threshold.
